(19) United States
(12) Patent Application Publication
(10) Pub. No.: US 2025/0266193 A1
(43) Pub. Date: Aug. 21, 2025

(54) MAGNETIC WIRE MATERIAL AND METHOD FOR PRODUCING MAGNETIC WIRE MATERIAL

(71) Applicants: DAIDO STEEL CO., LTD., Nagoya-shi (JP); NIPPON SEISEN CO., LTD., Osaka (JP)

(72) Inventors: Akihiko SAITO, Nagoya-shi (JP); Kosuke Yuasa, Nagoya-shi (JP); Takayuki Akizuki, Ikoma-shi (JP); Takayuki Seo, Osaka-shi (JP)

(21) Appl. No.: 19/058,396

(22) Filed: Feb. 20, 2025

(30) Foreign Application Priority Data
Feb. 21, 2024 (JP) 2024-024673

(51) Int. Cl. H01F 1/147; B21C 1/02; C21D 6/00; C21D 9/52; C22C 19/03; C22C 38/04; C22C 38/08; C22F 1/10; H01F 41/02

(52) U.S. Cl. CPC H01F 1/14708; B21C 1/02; C21D 6/001; C21D 6/005; C21D 9/525; C22C 19/03; C22C 38/04; C22C 38/08; C22F 1/10; H01F 41/02; C22C 2202/02

(57) ABSTRACT

Provided is a magnetic wire material containing an alloy containing 40 mass % or more and 50 mass % or less of Ni, with the balance being Fe and unavoidable impurities, in which in a cross section of the wire material along an axial direction thereof, a proportion of a crystal structure in which an angle difference between the axial direction and a <111> direction is 10° or less is 20% or more.

### CROSS-REFERENCE TO RELATED APPLICATIONS

This application is based on and claims priority under 35 USC 119 from Japanese Patent Application No. 2024-024673 filed on Feb. 21, 2024, the contents of which are incorporated herein by reference.

### TECHNICAL FIELD

The present invention relates to a magnetic wire material and a method for producing a magnetic wire material, and more particularly to a magnetic wire material that is constituted of a permalloy and has a controlled texture, and a method for producing the magnetic wire material.

### BACKGROUND ART

Permalloys such as a permalloy PE (JISC2531: 1999) are soft magnetic materials capable of achieving a high magnetic flux density and a high magnetic permeability, and thus have been widely used as a constituent material of a magnetic core, a yoke, or the like mounted on various devices such as a sensor. In particular, as described in Patent Literature 1 and the like, in the case where a permalloy is processed into a strip material to control its texture, magnetic properties can be improved. For example, when a permalloy PE strip is produced, a recrystallization texture in which a <100> orientation that is an axis of easy magnetization is oriented in a rolling direction can be obtained by performing a cold working at a rolling reduction rate of 95% or more and then performing a heat treatment at a temperature of 1000° C. or higher. The thus-obtained permalloy PE strip tends to have a high squareness ratio of 90% or more in a demagnetization curve, and can be suitably used for a core material or the like of a saturable transformer in the form of an annular wound magnetic core, a laminated iron core, or the like.

### CITATION LIST

### Patent Literature

Patent Literature 1: JPH07-98975B

### SUMMARY OF INVENTION

As described above, in order to impart excellent magnetic properties such as a squareness ratio of 90% or more to a permalloy strip material, it is required to perform a cold working at a high rolling reduction rate such as a rolling reduction rate of 95% or more, and the thickness of the obtained strip material is reduced. As a result, in order to produce a product requiring a relatively large thickness, it is required to laminate a large number of strip materials. For example, in response to the demand for higher currents in electric vehicles in recent years, it is required to pass a large magnetic flux through a core material of a saturable transformer or a current sensor mounted on an automatic vehicle, and a laminated core in which a large number of permalloy strip materials are laminated has been used. As a larger number of strip materials are laminated in this way, the lamination steps become more complicated, and the production cost of the product increases. As the permalloy strip material is formed thinner, the loss due to an eddy current tends to increase. For example, in recent years, with the spread of wireless power supply systems, there is an increasing demand for soft magnetic back yokes placed on a back side of a receiving coil in order to improve power supply efficiency, and permalloy strip materials have been also used for this application. However, the power supply system is driven in a high frequency range such as 85 kHz, and therefore, an eddy current loss in the permalloy strip material and heat generation caused by the eddy current loss tend to become problems. As described above, in the case where the permalloy strip material is processed at a high rolling reduction rate, magnetic properties such as a magnetic flux density and a squareness ratio are improved. However, as the strip material becomes thinner, problems such as the necessity of multi-layer lamination and increased eddy current loss become more severe. It is desired to develop a soft magnetic material capable of exhibiting excellent magnetic properties without extremely reducing the thickness of the material.

In the permalloy strip material, the <100> direction, which is the axis of easy magnetization, is easily oriented in the rolling direction. This causes the permalloy strip material to have excellent magnetic properties such as a high magnetic flux density and a high magnetic permeability. On the other hand, when the axis of easy magnetization is oriented in the rolling direction, the magnetization is more easily saturated at a low magnetic field. Therefore, it is difficult to use a permalloy strip in applications, such as a large-current sensor, in which a soft magnetic material is desired not to cause saturation of magnetization easily even in a high magnetic field. If a soft magnetic material that hardly causes saturation of magnetization even in a high magnetic field can be obtained, the soft magnetic material can be suitably used for applications in which a high magnetic field is generated.

An object of the present invention is to provide a soft magnetic material that is excellent in magnetic properties such as a magnetic permeability and hardly causes saturation of magnetization even in a high magnetic field without extremely reducing the thickness of the material, and to provide a method for producing such a soft magnetic material.

As a soft magnetic material and a method for producing a soft magnetic material for solving the above problems, a magnetic wire material and a method for producing a magnetic wire material according to the present invention have the following configurations.

[1]A magnetic wire material according to the present invention contains an alloy containing 40 mass % or more and 50 mass % or less of Ni, with the balance being Fe and unavoidable impurities, in which in a cross section of the wire material along an axial direction thereof, a proportion of a crystal structure in which an angle difference between the axial direction and a <111> direction is 10° or less is 20% or more.

[2] In the magnetic wire material according to the aspect [1], the alloy may further contain 0.3 mass % or more and 0.7 mass % or less of Mn.

[3] In the magnetic wire material according to the aspect [1] or [2], the magnetic wire material may have a wire diameter of 0.1 mm or more and 30 mm or less.

The method for producing a soft magnetic material according to the present invention has the following configuration.

A method for producing a magnetic wire material according to the present invention contains: a wire-drawing step of drawing an alloy material containing 40 mass % or more and 50 mass % or less of Ni, with the balance being Fe and unavoidable impurities, to obtain a wire material; and a heat treatment step of performing a heat treatment on the wire material obtained in the wire-drawing step, in which when a reduction of area in the wire-drawing step is defined as Red (%) and a wire diameter of the wire material after the wire-drawing is defined as 4 (mm), Red·ϕ is 49 or more.

[5] In the method for producing a magnetic wire material according to the aspect [4], the alloy material may further contain 0.3 mass % or more and 0.7 mass % or less of Mn.

[6] In the method for producing a magnetic wire material according to the aspect [4] or [5], the wire diameter ϕ of the wire material may be reduced to be 0.1 mm or more and 30 mm or less in the wire-drawing step.

[7] In the method for producing a magnetic wire material according to any one of the aspects [4] to [6], the reduction of area Red may be 85% or more in the wire-drawing step.

[8] In the method for producing a magnetic wire material according to any one of the aspects [4] to [7], the wire material may be heated at a temperature of 700° C. or higher in the heat treatment step.

The magnetic wire material according to the present invention, which has the configuration of the above [1], has a component composition of a permalloy PE or close thereto, and exhibits a high magnetic flux density and a high magnetic permeability. When the permalloy material is processed into a wire material having a predetermined wire diameter, the wire may be drawn, and the texture of the crystal can be controlled through the wire-drawing. In the case where the permalloy material has a shape of a wire material, the texture can be controlled without extremely reducing the dimension in a specific direction, such as the thickness of a strip material. In addition, when the strip material is formed by rolling, rolling occurs only in one direction, whereas when the wire material is drawn, the reduction in the wire diameter proceeds two-dimensionally, so that the wire material can more easily increase the degree of processing than the strip material, and can more effectively achieve control of the texture by processing and improvement in the magnetic properties such as the squareness ratio.

Further, according to studies by the present inventors, it can be seen that when a wire material is produced by subjecting a permalloy material having the above component composition to a wire-drawing and a heat treatment, the crystal orientation oriented along the wire-drawing direction (axial direction) can be controlled depending on the conditions during the wire-drawing. When Red˜ϕ is increased in which Red (%) represents a reduction of area in the wire-drawing step and ϕ (mm) represents a wire diameter of the wire material after the wire-drawing, it becomes easier to orient the crystal structure toward the <111> direction that is the axis of hard magnetization along the axial direction. Accordingly, it is possible to form a state where the proportion of the crystal structure in which the angle difference between the axial direction and the <111> direction is 10° or less is 20% or more in the cross section along the axial direction of the wire material. As a result, when the magnetic field along the axial direction of the wire material is applied, the saturation of the magnetization hardly occurs.

As described above, by using a permalloy material having a predetermined composition as a wire material and ensuring a large proportion of a crystal structure in which the <111> direction is oriented in the axial direction of the wire material, a soft magnetic material having excellent magnetic properties and hardly causing saturation of magnetization can be obtained without excessively reducing the thickness of the material. This magnetic wire material can be used as a core material which can cope with an increase in current or as a yoke material which inhibits the eddy current loss, without the need to laminate the materials in multiple layers.

In the aspect of the above [2], the magnetic wire material contains a predetermined amount of Mn. Mn enhances workability of the permalloy material during the wire-drawing, and in the case where Mn is contained in the wire material in the predetermined amount, a wire-drawing at a high reduction of area is easily performed while maintaining excellent magnetic properties.

In the aspect of the above [3], the wire diameter of the magnetic wire material is 0.1 mm or more and 30 mm or less. Accordingly, it is possible to obtain a wire material having excellent magnetic properties and a high effect of preventing saturation of magnetization in a high magnetic field.

The method for producing a soft magnetic material according to the present invention has the following configuration.

In the method for producing a magnetic wire material according to the present invention, which has the configuration of the above [4], an alloy material of a permalloy having a predetermined composition is drawn with Red·ϕ of 49 or more, and then subjected to a heat treatment. Accordingly, it is possible to efficiently produce the magnetic wire material in which the proportion of the crystal structure in which the angle difference between the axial direction and the <111> direction is 100 or less is 20% or more in the cross section along the axial direction. Unlike the strip material, the obtained wire material does not have an extremely small dimension in a specific direction, and by ensuring a large proportion of the crystal structure in which the <111> direction, which is the axis of hard magnetization, is oriented in the axial direction of the wire material, saturation of magnetization hardly occurs even in a high magnetic field.

In the aspect of the above [5], in the case where the alloy material contains a predetermined amount of Mn, workability in the wire-drawing step can be enhanced while maintaining excellent magnetic properties of the obtained wire material.

In the aspect of the above [6], in the wire-drawing step, the wire diameter ϕ of the obtained wire material is 0.1 mm or more and 30 mm or less. Accordingly, it is possible to produce a wire material having excellent magnetic properties and a high effect of preventing saturation of magnetization in a high magnetic field.

In the aspect of the above [7], the reduction of area Red is 85% or more in the wire-drawing step. In this case, the produced wire material can easily achieve the state where the proportion of the crystal structure in which the <111> direction is oriented in the axial direction of the wire material is large.

In the aspect of the above [8], the heat treatment step is performed at a temperature of 700° C. or higher. Accordingly, it is easy to produce a wire material exhibiting good soft magnetic properties, in which the proportion of the crystal structure in which the <111> direction is oriented in the axial direction of the wire material is large, through recrystallization in the heat treatment step.

### BRIEF DESCRIPTION OF DRAWINGS

FIG. 1 is a diagram showing a frequency distribution of crystal orientations in Example 1.

FIG. 2 is a diagram showing a frequency distribution of crystal orientations in Comparative Example 1.

FIG. 3 is a diagram showing a frequency distribution of crystal orientations in Comparative Example 2.

### DESCRIPTION OF EMBODIMENTS

Hereinafter, a magnetic wire material according to an embodiment of the present invention and a method for producing a magnetic wire material will be described in detail.

### [Magnetic Wire Material]

First, a magnetic wire material according to an embodiment of the present invention will be described. The magnetic wire material according to the present embodiment is formed as a wire material made of a permalloy. Specifically, the magnetic wire material is made of an alloy having the following component composition. The magnetic wire material has a component composition classified as a permalloy PE or a component composition close to the permalloy PE.

The alloy constituting the magnetic wire material may contain 40 mass % or more and 50 mass % or less of Ni, with the balance being Fe and unavoidable impurities. Ni imparts excellent magnetic properties such as a high magnetic flux density and a high magnetic permeability to a soft magnetic material. In the case where the content of Ni is 40 mass % or more, a high effect of improving the magnetic properties is obtained. The content of Ni is more preferably 45 mass % or more.

On the other hand, in the case where the soft magnetic material contains too much Ni, the magnetic properties may rather worsen. In addition, a material cost of the soft magnetic material increases. From the viewpoint of maintaining excellent magnetic properties and reducing the material cost, the content of Ni is set to 50 mass % or less. The content of Ni is more preferably 48 mass % or less.

The alloy constituting the magnetic wire material may further contain 0.3 mass % or more and 0.7 mass % or less of Mn as an optional element. Mn improves cold workability of the soft magnetic material. In the case where the alloy constituting the magnetic wire material has high cold workability, the wire material can be drawn at a high reduction of area while avoiding the occurrence of cracking in the wire material. As described below, the texture can be effectively controlled by performing wire-drawing at a sufficiently high reduction of area. On the other hand, in the case where the content of Mn is too high, magnetic properties such as a magnetic flux density decrease. In the case where the content of Mn is within the above range, the effect of improving cold workability can be enhanced while maintaining excellent magnetic properties such as a magnetic permeability and a magnetic flux density in the magnetic wire material. In addition, examples of the unavoidable impurities that can be contained in the alloy constituting the magnetic wire material include 0.02 mass % or less of C, 0.01 mass % or less of N, 0.01 mass % or less of P, 0.01 mass % or less of O, and 0.01 mass % or less of S.

The magnetic wire material according to the present embodiment has a texture in which an orientation of the crystal structure in a <111> direction is promoted along an axial direction (longitudinal direction) of the wire material. Specifically, the <111> orientation degree is 20% or more in a cross section extending along the axial direction of the magnetic wire material. Here, the <111> orientation degree refers to a proportion of an area occupied by a crystal structure (<111> structure) in which the angle difference between the axial direction and the <111> direction is 10° or less. The <100> orientation degree described below refers to a proportion of an area occupied by a crystal structure (<100> structure) in which the angle difference between the axial direction and the <100> direction is 10° or less. The distribution of crystal orientations in the wire material can be evaluated by electron backscatter diffraction (EBSD), and in the results of EBSD measurement for a cross section obtained by cutting the wire material along the axial direction, proportions of areas occupied by the structure where the <111> direction is oriented within 100 and the structure where the <100> direction is oriented within 10° with respect to the axial direction, may be estimated respectively.

In a cubic crystal of a Fe—Ni alloy, the axis of easy magnetization is the <100> direction, and the axis of hard magnetization is the <111> direction. In the magnetic wire material according to the present embodiment, the orientation of the <111> direction, which is the axis of hard magnetization, in the axial direction is promoted, so that magnetization saturation hardly occurs even when a high magnetic field is applied along the axial direction. Therefore, even in a high magnetic field, the magnetic wire material can function as a soft magnetic material while maintaining excellent magnetic properties such as a high magnetic permeability, which are obtained as effects of the component composition of the magnetic wire material. As compared with the <111> structure, the <100> structure is more stable in terms of surface energy, and in thermodynamics, the <100> structure is more dominant than the <111> structure. However, as described below, the <111> orientation degree of the magnetic wire material can be increased by controlling conditions in the wire-drawing step during the production of the magnetic wire material. In the magnetic wire material, when the <111> orientation degree is increased to 20% or more, the effect of preventing the saturation of magnetization under a high magnetic field environment can be enhanced. The <111> orientation degree is more preferably 40% or more. The higher the <111> orientation degree is, the higher the effect of preventing the saturation of magnetization can be obtained, and therefore, an upper limit is not particularly set for the <111> orientation degree. However, the actually and easily realizable <111> orientation degree is approximately 80% or less.

In the case where the <111> orientation degree is 20% or more in the cross section extending along the axial direction of the magnetic wire material, the relationship with the <100> orientation degree is not particularly limited. However, from the viewpoint of enhancing the effect of preventing saturation of magnetization by the <111> structure, the <100> orientation degree is preferably low. For example, the <100> orientation degree may be preferably reduced to less than 30%, more preferably less than 25%, and still more preferably less than 20%. The <111> orientation degree may be preferably 90% or more, and more preferably 95% or more of the <100> orientation degree. Further, the <111> orientation degree may be larger than the <100> orientation degree.

The wire diameter of the magnetic wire material according to the present embodiment is not particularly specified, and is preferably 0.1 mm or more. By maintaining the wire diameter of the magnetic wire material so as not to be excessively small, the volume of the magnetic wire material can be sufficiently ensured, and the magnetic properties as a soft magnetic material can be easily exhibited. In addition, in the case where the wire diameter is large, the specific surface area is reduced. Therefore, the <111> structure which is unstable in terms of surface energy can be easily retained. Such a magnetic wire material is also suitable for practical use as a core material or a yoke material. The wire diameter is more preferably 0.3 mm or more and further preferably 0.5 mm or more. On the other hand, the wire diameter of the magnetic wire material is preferably reduced to 30 mm or less. By the wire-drawing step controlled under this condition, a texture having a high <111> orientation degree can be formed, and a magnetic wire material having a high effect of preventing saturation of magnetization in a high magnetic field can be obtained. The wire diameter is more preferably 10 mm or less, and further preferably 5 mm or less.

The magnetic wire material according to the present embodiment has excellent magnetic properties such as a high magnetic flux density, a high magnetic permeability, and a high squareness ratio due to the effect of the component composition and the effect of receiving the control of the texture in the process of being processed into a wire material. Therefore, the magnetic wire material according to the present embodiment can be suitably used as a material constituting a soft magnetic member such as a magnetic core and a yoke. In particular, the magnetic wire material has a high <111> orientation degree and therefore, saturation of magnetization hardly occurs even when a high magnetic field is applied, and excellent magnetic properties such as a high magnetic permeability can be maintained. By utilizing this, the magnetic wire material according to the present embodiment can be particularly suitably used in applications in which a high magnetic field is generated, such as a core material of a current sensor for a large current. The magnetic wire material may be incorporated into various devices such as a sensor such that the axial direction of the magnetic wire material is directed along the direction in which the magnetic field is applied.

Conventionally, the texture of a permalloy was generally intended to be controlled by processing the permalloy into a strip material by rolling the permalloy at a high rolling reduction rate. However, by taking the shape of the wire material as in the magnetic wire material according to the present embodiment, the control of the texture by processing can be achieved without extremely reducing the dimension in a specific direction as in the thickness direction of the strip material. In order to ensure the thickness of the material (core), in the case of a strip material, a step of laminating a large number of materials is required. However, in the case of a wire material, the steps required for lamination and the cost thereof can be reduced because the thickness can be ensured without lamination. In the case where it is required to ensure a large volume of the material, a plurality of wire materials may be bound as appropriate, and this step can be performed more easily than the lamination. In addition, in the wire material, the thickness of the material does not become extremely small, and therefore, the eddy current loss and heat generation caused thereby, which tend to be problems in a thin strip material, are restricted to be small. Therefore, the wire material according to the present embodiment can also be suitably used in applications in which the wire material is used in a high frequency range and heat generation due to eddy current loss is likely to become a problem, such as a back yoke of a wireless power supply system. In the case of the strip material, the rolling is performed in one direction during the production, whereas in the case of the wire material, the diameter is reduced by applying a force two-dimensionally from the entire outer periphery toward the center in the wire-drawing step. Therefore, the processing degree can be easily increased as compared with the strip material, and as a result, the control of the texture by the processing, that is, the orientation in the <111> direction in the axial direction can be effectively achieved. In addition, the wire material has an advantage that the wire material can also be disposed in a place where the strip material cannot be disposed, such as in a pipe.

### [Method for Producing Magnetic Wire Material]

Hereinafter, a method for producing a magnetic wire material according to an embodiment of the present invention will be described. When the production method according to the present embodiment is used, the magnetic wire material according to the embodiment of the present invention described above can be suitably produced. In the production method according to the present embodiment, a wire-drawing step and a heat treatment step are performed in this order to produce the magnetic wire material.

In the wire-drawing step, an alloy material having a predetermined composition is drawn and reduced in diameter to form a wire material having a predetermined wire diameter. Here, the alloy material subjected to the wire-drawing step has the same composition as the magnetic wire material according to the embodiment of the present disclosure described above. That is, an alloy material containing 40 mass % or more and 50 mass % or less of Ni, with the balance being Fe and unavoidable impurities, may be used. Alternatively, the alloy material may further contain 0.3 mass % or more and 0.7 mass % or less of Mn. After the alloy material having a predetermined component composition is produced by melting and casting, a wire-drawing step may be performed while interposing a hot treatment as appropriate. For example, a wire material having a predetermined wire diameter and a predetermined reduction of area may be produced by repeating a wire-drawing with reduction of area of 70% or more and a heat treatment at 700° C. or higher.

In the wire-drawing step, the processing conditions are defined by the reduction of area Red (%) and the wire diameter #(mm) of the wire material after the wire-drawing. The reduction of area Red is obtained by displaying the amount of decrease in the cross-sectional area of the wire material due to the wire-drawing at a ratio based on the cross-sectional area before the wire-drawing. In the production method according to the present embodiment, the wire-drawing is performed such that a product Red·ϕ of the reduction of area Red and the wire diameter ϕ after the wire-drawing is 49 or more. By performing the wire-drawing under this condition, the magnetic material according to the embodiment of the present disclosure having a <111> orientation degree of 20% or more in the cross section along the axial direction can be easily obtained through the subsequent heat treatment step.

With the wire-drawing step, the crystal structure in the wire material can be oriented in a certain direction, and in particular, as the reduction of area is increased, the orientation of the crystal structure is improved. In the Fe—Ni alloy, in the wire-drawing step, the <111> direction is preferentially oriented along the wire-drawing direction (that is, the axial direction), as compared with the <100> direction. Therefore, as the reduction of area is increased, the <111> orientation degree of the obtained magnetic wire material tends to be increased. On the other hand, as described above, in terms of surface energy, the <100> structure is more stable than the <111> structure, and as the wire diameter is reduced and the specific surface area increases, the <100> structure is more likely to be formed. That is, when the wire diameter after the wire-drawing is set large, the <111> orientation degree is easily increased. As described above, from the two factors, as the product Red·ϕ of the reduction of area and the wire diameter after the wire-drawing is increased, a magnetic wire material having a larger <111> orientation degree is easily obtained. As shown in the following Examples, when Red·ϕ is 49 or more, a magnetic wire material having a <111> orientation degree of 20% or more in a cross section along the axial direction can be suitably produced. Red·ϕ is more preferably 60 or more, and still more preferably 80 or more. The larger the Red·ϕ is, the more preferred it is, and therefore, there is no particular upper limit. However, Red·ϕ that can be implemented by an actual wire-drawing operation is approximately 200 or less and may be 95 or less. The wire-drawing may be performed as a cold working under room temperature or the like.

As long as the product Red·ϕ of the reduction of area and the wire diameter after the wire-drawing is 49 or more, the individual values of the reduction of area Red and ϕ are not particularly limited. However, for example, the reduction of area of preferably 85% or more, more preferably 90% or more, and still more preferably 95% or more, can achieve a high effect of improving the <111> orientation degree. The higher the reduction of area is, the more preferred it is, and there is no particular upper limit. As described above for the magnetic wire material, the wire diameter is preferably 0.1 mm or more and 30 mm or less.

In the heat treatment step, the wire material after the wire-drawing is subjected to a heat treatment (magnetic annealing). The heating conditions in the heat treatment step are not particularly limited, and may be appropriately determined so as to sufficiently achieve the purpose of magnetic annealing, that is, so as to sufficiently achieve the removal of working strain and the improvement of soft magnetic properties including the reduction of coercivity associated therewith. For example, the heating temperature is preferably 700° C. or higher, and more preferably 1000° C. or higher. The heating temperature is preferably kept at 1200° C. or lower. The heating time may be, for example, 30 minutes or longer and 180 minutes or shorter. Examples of the atmosphere during the heat treatment include hydrogen, argon, and vacuum.

### EXAMPLES

Hereinafter, the present invention will be described more specifically with reference to Examples. The present invention is not limited by these Examples.

### [Preparation of Sample]

Wire materials according to Examples 1 to 5 and Comparative Examples 1 to 8 were produced. That is, alloy materials containing Ni (and Mn) in the respective amounts shown in Table 1, with the balance being Fe and unavoidable impurities, were melted and cast. Then, except for Comparative Examples 4 and 5, a wire-drawing with a reduction of area of 70% or more and a heat treatment at 700° C. or higher were repeated to obtain wire materials having the wire diameter and the reduction of area shown in Table 1. Thereafter, each of the obtained wire materials was subjected to a heat treatment at 1100° C. for 1 hour in a hydrogen atmosphere.

### [Test Methods]

Each sample was cut along the axial direction to prepare a cross-sectional sample, and an electron backscatter diffraction (EBSD) measurement was performed on the cross-sectional sample. In the EBSD measurement, the observation range was set such that 100 or more crystal grains were present in the field of view. In the results of the EBSD measurement, at a plurality of measurement points (electron beam spots), angles with respect to the <111> orientation were measured, and a distribution of the angles was calculated to obtain a frequency distribution of the crystal orientations. Then, a value obtained by integrating the obtained frequency distribution in a region of an angle of 0° to 10° was defined as the <111> orientation degree. In addition, since the angle formed between the <100> orientation and the <111> orientation was about 55°, a value obtained by integrating the obtained frequency distribution in a region of an angle of 45° to 55° was defined as the <100> orientation degree.

### [Test Results]

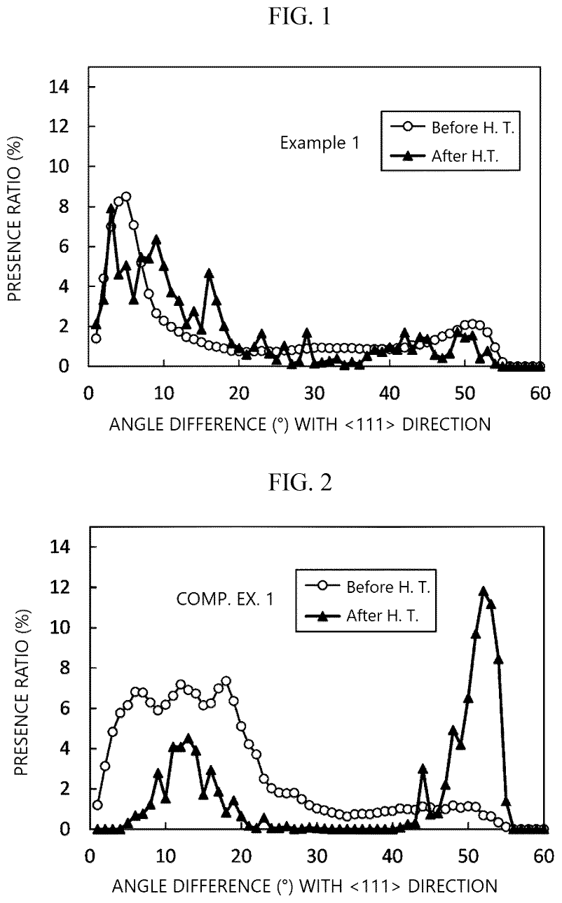

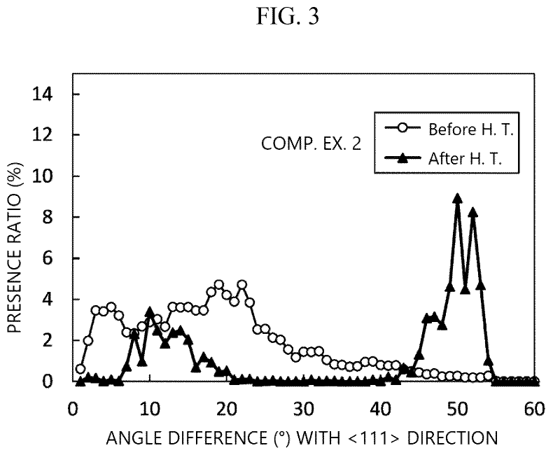

Table 1 shows the contents of Ni and Mn and the conditions during wire-drawing, and the <111> orientation degree and the <100> orientation degree obtained by the EBSD measurement for Examples 1 to 5 and Comparative Examples 1 to 8. As representative examples, FIG. 1 shows a frequency distribution of crystal orientations in Example 1, FIG. 2 shows a frequency distribution of crystal orientations in Comparative Example 1, and FIG. 3 shows a frequency distribution of crystal orientations in Comparative Example 2. In each figure, the frequency distribution of the state before the heat treatment (Before H. T.) is also shown.

TABLE 1

| | Ni | Mn | Wire | Reduction | | <111> | <100> |
|---|---|---|---|---|---|---|---|
| Sample | amount | amount | diameter | of area | | orientation | orientation |
| No. | (mass %) | (mass %) | ϕ (mm) | Red (%) | Red · ϕ | degree (%) | degree (%) |
| Ex. 1 | 47 | 0.5 | 1.0 | 85.0 | 85.0 | 48.7 | 7.6 |
| Ex. 2 | 47 | 0.3 | 0.5 | 98.7 | 49.4 | 24.6 | 25.1 |
| Ex. 3 | 40 | 0.7 | 1.0 | 85.2 | 85.2 | 41.5 | 6.7 |
| Ex. 4 | 50 | 0.5 | 1.0 | 85.0 | 85.0 | 50.1 | 8.3 |
| Ex. 5 | 47 | 0 | 1.0 | 85.2 | 85.2 | 45 | 45 |
| Comp. | 47 | 0.5 | 0.3 | 98.7 | 29.6 | 7.2 | 61.1 |
| Ex. 1 | | | | | | | |
| Comp. | 47 | 0.3 | 0.1 | 99.9 | 10.0 | 6.6 | 54.9 |
| Ex. 2 | | | | | | | |
| Comp. | 47 | 0.5 | 0.3 | 80.0 | 24.0 | 12.2 | 40.9 |
| Ex. 3 | | | | | | | |
| Comp. | 47 | 0.7 | 0.3 | 50.0 | 15.0 | 13.8 | 9.9 |
| Ex. 4 | | | | | | | |
| Comp. | 47 | 0.7 | 0.3 | 30.0 | 9.0 | 7.4 | 2.9 |
| Ex. 5 | | | | | | | |
| Comp. | 35 | 0.5 | 1.0 | 85.0 | 85.0 | 20 | 5 |
| Ex. 6 | | | | | | | |
| Comp. | 55 | 0.5 | 1.0 | 85.0 | 85.0 | 19 | 4 |
| Ex. 7 | | | | | | | |
| Comp. | 47 | 0 | 0.3 | 99.0 | 29.7 | 7 | 52 |
| Ex. 8 | | | | | | | |

According to the frequency distribution of crystal orientations in Example 1 (after heat treatment: After H. T.) shown in FIG. 1, the presence ratios of the crystal structure were intensively distributed in a peak shape sharply rising from an angle of 0° in a region where the angle difference with the <111> direction was small. That is, it can be seen that the generation of the <111> structure was promoted. The integral of the presence ratios in the range of 0° to 10° was the <111> orientation degree shown in Table 1, which was 48.7% . This value was significantly larger than the <100> orientation degree obtained by integrating the presence ratios in the range of 45° to 55°.

On the other hand, according to the frequency distributions of the crystal orientations of Comparative Examples 1 and 2 (after heat treatment: After H. T.) shown in FIGS. 2 and 3, the presence ratios of the crystal structure were intensively distributed in a region (about 400 or more) having a large angle difference with the <111> direction. A peak-shaped distribution was also observed in a region at an angle of 20° or less, and this can be associated with a (100) twin crystal. From these, it can be seen that the generation of the <100> structure was promoted. As shown in Table 1, in each of Comparative Examples 1 and 2, the value of the <100> orientation degree was significantly larger than the value of the <111> orientation degree.

For each data other than the frequency distributions of the crystal orientations shown in FIGS. 1, 2, and 3, similarly, the <111> orientation degree and the <100> orientation degree estimated from the frequency distributions were shown in Table 1. According to this, among Examples 1 to 5 and Comparative Examples 1 to 5 and 8 in which the content of Ni fell within the range of 40 mass % or more and 50 mass % or less, in Examples 1 to 5, the <111> orientation degree was 20% or more, and it can be seen that the formation of the <111> structure was promoted. In Examples 1 to 5, the wire-drawing was performed under the condition that Red·ϕ was 49 or more. On the other hand, in any of Comparative Examples 1 to 5 and 8, the <111> orientation degree did not reach 20%. In particular, in Comparative Examples 1 to 3 and 8, large values of the <100> orientation degree are shown. In Comparative Examples 1 to 5 and 8, the wire-drawing was performed under the condition that Red·ϕ was less than 49. From these results, it can be seen that the orientation of the crystal structure can be controlled by Red·ϕ, which is the product of the reduction of area and the wire diameter after wire-drawing, as the condition during wire-drawing, and the orientation of the <111> direction of the crystal structure in the axial direction can be promoted by increasing the value of Red·ϕ. Neither the reduction of area Red nor the wire diameter #showed a high correlation with the <111> orientation degree or the <100> orientation degree when used alone.

Here, in each frequency distribution shown in FIGS. 1 to 3, when the state before the heat treatment is observed, in any of Example 1 shown in FIG. 1 and Comparative Examples 1 and 2 shown in FIGS. 2 and 3, the presence ratios were concentrated in a region where the angle difference with the <111> direction was small before the heat treatment. It is considered that this is because the orientation in the <111> direction occurred preferentially over the orientation in the <100> direction along the axial direction in the wire-drawing step. On the other hand, when the heat treatment was performed, the frequency distribution did not greatly change in Example 1 shown in FIG. 1, whereas the frequency distribution greatly changed in Comparative Examples 1 and 2 shown in FIGS. 2 and 3. That is, as described above, the state where the orientation in the <111> direction was high was maintained in FIG. 1, whereas the state was changed to the state where the orientation in the <100> direction was high in FIGS. 2 and 3. This can be interpreted as being due to the fact that the <100> structure is more thermally stable than the <111> structure. That is, it is considered that in Example 1 shown in FIG. 1A in which the wire diameter was as relatively large as 1.0 mm and the specific surface area was small, the state obtained by wire-drawing where the <111> orientation was dominant was maintained even after the heat treatment, whereas in Comparative Examples 1 and 2 shown in FIGS. 2 and 3 in which the wire diameter was as small as 0.3 mm and 0.1 mm and the specific surface area was large, the state was changed to a thermodynamically stable state where the <100> orientation was dominant through the heat treatment. From this, it can be said that in order to obtain a texture with a high <111> orientation degree, it is effective to make the wire diameter not too small and at the same time, to ensure the reduction of area sufficient to sufficiently increase the orientation in the <111> direction by wire-drawing, to thereby increase the value of the product Red·ϕ of the reduction of area and the wire diameter so as to sufficiently prevent the change in the orientation to the <100> direction during the heat treatment.

In Examples 1 to 5 and Comparative Examples 1 to 3 and 8, a high orientation was exhibited in the <111> direction and the <100> direction through the wire-drawing at a high reduction of area of 80% or more and the heat treatment, whereas in Comparative Examples 4 and 5, the reduction of area during wire-drawing was as low as 50% or less, and the Red·ϕ was also kept at a small value of 25 or less. In Comparative Examples 4 and 5, unlike Examples 1 to 5 and Comparative Examples 1 to 3 and 8, both the <111> orientation degree and the <100> orientation degree were small values less than 20%. It is considered that in Comparative Examples 4 and 5, the control of the texture could not be sufficiently achieved due to the low degree of processing during wire-drawing, and the orientation of the crystal structure in a specific direction did not effectively occur.

In Comparative Examples 6 and 7, the content of Ni was out of the range of 40 mass % or more and 50 mass % or less. In Comparative Examples 6 and 7, the wire diameter ϕ and the reduction of area Red were the same as those in Example 1, but the <111> orientation degree was reduced to half or less compared with Example 1. From this, it can be seen that the component composition of the alloy also affects the orientation of the crystal structure.

The embodiments and Examples of the present invention have been described above. The present invention is not particularly limited to these embodiments and Examples, and various modifications may be made.

What is claimed is:

1. A magnetic wire material comprising:
an alloy comprising 40 mass % or more and 50 mass % or less of Ni, with the balance being Fe and unavoidable impurities,
wherein in a cross section of the wire material along an axial direction thereof, a proportion of a crystal structure in which an angle difference between the axial direction and a <111> direction is 10° or less is 20% or more.

2. The magnetic wire material according to claim 1, wherein the alloy further comprises 0.3 mass % or more and 0.7 mass % or less of Mn.

3. The magnetic wire material according to claim 1, having a wire diameter of 0.1 mm or more and 30 mm or less.

4. A method for producing a magnetic wire material, the method comprising:
a wire-drawing step of drawing an alloy material comprising 40 mass % or more and 50 mass % or less of Ni, with the balance being Fe and unavoidable impurities, to obtain a wire material; and
a heat treatment step of performing a heat treatment on the wire material obtained in the wire-drawing step,
wherein when a reduction of area in the wire-drawing step is defined as Red (%) and a wire diameter of the wire material after the wire-drawing is defined as ϕ (mm), Red·ϕ is 49 or more.

5. The method for producing a magnetic wire material according to claim 4, wherein the alloy material further comprises 0.3 mass % or more and 0.7 mass % or less of Mn.

6. The method for producing a magnetic wire material according to claim 4, wherein the wire diameter ϕ of the wire material is reduced to be 0.1 mm or more and 30 mm or less in the wire-drawing step.

7. The method for producing a magnetic wire material according to claim 4, wherein the reduction of area Red is 85% or more in the wire-drawing step.

8. The method for producing a magnetic wire material according to claim 4, wherein the wire material is heated at a temperature of 700° C. or higher in the heat treatment step.
